(19) United States
(12) Patent Application Publication
(10) Pub. No.: US 2021/0378176 A1
(43) Pub. Date: Dec. 9, 2021

(54) CONTROLLER FOR AN AGRICULTURAL HARVESTER

(71) Applicant: CNH Industrial America LLC, New Holland, PA (US)

(72) Inventors: Arno Leenknegt, Hooglede (BE); Pieter Maelegheer, Knokke-Heist (BE); Thomas Mahieu, Ieper (BE); Bart M.A. Missotten, Herent (BE); Brecht Vanmullem, Koekelare (BE)

(21) Appl. No.: 17/280,642

(22) PCT Filed: Sep. 27, 2019
(86) PCT No.: PCT/EP2019/076165

§ 371 Date: Mar. 26, 2021

(30) Foreign Application Priority Data
Sep. 28, 2018 (BE) 2018/5666

(51) Int. Cl. A01D 41/127; G05D 1/00; G05D 1/02

(52) U.S. Cl. CPC A01D 41/1277; A01D 41/1274; A01F 7/06; G05D 1/0223; G05D 1/0088

(57) ABSTRACT

A controller for controlling a harvesting performance of an agricultural harvester. The controller receives automation settings, selected by an operator via a human-machine interface. The controller also receives data from on-board harvester sensors. The controller defines a target value for quality parameters based on the automation settings, and determines a current value of each of the quality parameters in dependence on the crop sensor data. The controller determines an actuator setting for actuators of the agricultural harvester when the current value of one or more of the plurality of quality parameters differs by greater than an acceptable amount from the associated target value. The actuator setting is determined in dependence on the automation settings and the target value. The controller controls the actuators to achieve the determined actuator setting.

### TECHNICAL FIELD

The present invention relates to a controller for controlling a harvesting performance of an agricultural harvester. Aspects of the invention include a controller, to a method, and to an agricultural harvester.

### BACKGROUND OF THE INVENTION

Combine or agricultural harvesters harvest grain from a field and separate the grain kernels from all of the other material in the harvested crop. This other material is commonly referred to as ‘material other than grain’ or MOG and comprises, e.g., straw, leaves, ears and chaff. The grain kernels are collected whole and stored in a tank while the MOG is discharged from the rear of the harvester. Separating the grain from the MOG involves passing the crop through different processing stages of a crop processing system of the harvester. In a threshing stage, the grain kernels are separated from the chaff and the plant. A consecutive separation stage separates the straw and other larger parts in the grain-MOG mixture from the smaller grain kernels and the chaff. Then, a cleaning stage, typically comprising a blower for blowing away the light-weight chaff and a set of reciprocating sieves for letting through the heavier grain kernels, separates the grains from the chaff.

In any design of combine harvester, there are several operating parameters of the crop processing system that will affect the harvesting performance or quality. In particular, if the parameter values are incorrect for the current crop and/or harvesting conditions, the grain kernels may be broken, the grain collected in the grain tank may contain too much MOG, there may be an excess of tailings discharged from the cleaning stage, or there may be reduced processing efficiency resulting in grain loss.

Parameters such as grain purity, grain breakage, tailings quantity and grain loss, which may be referred to collectively as ‘crop quality parameters, may be measured either directly or indirectly by on-board harvester sensors so that the operator may be given an indication of crop processing or harvesting performance. However, conveying all the necessary information to the operator has resulted in ever more complex user interfaces making it difficult even for experienced operators to decide what to do when the crop quality parameters indicate that the harvesting performance is below a required, desired or optimal level. The problem is exacerbated by the fact that harvesters are often driven by less skilled operators because of a shortage of skilled labour.

It is an aim of the present invention to address one or more problems associated with the prior art.

### SUMMARY OF THE INVENTION

According to an aspect of the present invention there is provided a controller for controlling a harvesting performance of an agricultural harvester. The controller may comprise an input configured to receive at least one harvester automation setting, selected via an operator-input device. The input may be configured to receive crop sensor output data from a plurality of on-board harvester sensors. The controller may comprise a processor configured to define a target value for each of a plurality of quality parameters based on the at least one harvester automation setting. The processor may be configured to determine a current value of each of the plurality of quality parameters in dependence on the received crop sensor output data. The processor may be configured to determine an actuator setting for at least one actuator of the agricultural harvester when the current value of one or more of the plurality of quality parameters differs by greater than an acceptable amount from the associated target value, the at least one actuator setting being determined in dependence on the at least one harvester automation setting and said target value. The controller may comprise an output configured to send an actuator control signal to the at least one actuator to achieve the associated determined actuator setting. By automatically adjusting the actuator settings, the current values of the quality parameters may be brought to within the associated acceptable amounts of the target values.

In prior art systems, the operator controls operation of actuators to change actuator settings based on the measurements of certain operational parameters from on-board harvester sensors to optimise the harvesting performance of a combine. In particular, continuous adjustment of such actuators by the operator is needed, which requires a great deal of knowledge and experience, and which is difficult to maintain during a full working day. In addition, the harvester may only be operational for a few weeks per year, for example 4-6 weeks per year, which adds to the difficulty in finding skilled operators to operate the harvester. In any case, an increased number of actuators offering greater degrees of freedom for harvester performance adjustment, together with a greater number of sensors offering insight into a greater number of measures of the harvester performance, is increasing the complexity involved with operator-led adjustment. The present invention is advantageous in that adjustment of the actuators to improve harvester performance is automated. That is, the controller automatically controls adjustment of the actuators based on measured sensor values indicative of a plurality of quality parameters indicative of harvester performance, and based on operator-provided constraints, so as to optimise harvesting performance within the provided constraints.

The controller continually adjusts the internal processes of the harvester, via the actuators, so as to maximise the capacity of the harvester irrespective of the harvesting conditions, and irrespective of the speed at which the harvesting conditions change. In particular, the controller may automatically optimise operation of the harvester for different types of terrain, e.g. uphill or downhill, different levels of crop yield, different types of crop, different levels of moisture of a field, etc.

The automation of the internal processes of the combine allows the maximum capacity of the combine to be utilised in varying harvesting and crop conditions. By automating the process, the operator is freed up to focus on other tasks, such as unloading on the go, mapping, and harvest management. It also leads to reduced strain being placed on operators and, as less skill or experience is needed, it becomes easier to find operators.

The acceptable amount may take any appropriate form. For example, the acceptable amount may be predetermined and may be in the form of a range of values that includes the associated target value. The target value may be the upper limit of the range. The range may be a percentage tolerance either side of the target value.

The one or more actuator settings may include a ground speed setting of the agricultural harvester. The processor may be configured to determine the ground speed setting so that a throughput of the agricultural harvester does not increase when the current value of one or more of the plurality of quality parameters differs by greater than the acceptable amount from the associated target value. In particular, throughput may be controlled to remain at a substantially constant value or to decrease. Alternatively, or in addition, the one or more actuator settings may include an engine load setting of the agricultural harvester. The processor may be configured to determine the engine load setting so that a throughput of the agricultural harvester does not increase when the current value of one or more of the plurality of quality parameters differs by greater than the acceptable amount from the associated target value. That is, the throughput may be controlled by controlling the ground speed of the agricultural harvester and/or the engine load of the agricultural harvester.

The processor may be configured to determine the ground speed setting so as to increase the throughput when each of the plurality of current difference values differs by less than the acceptable amount from the associated target value. Alternatively, or in addition, the processor may be configured to determine the engine load setting so as to increase the throughput when each of the plurality of current difference values differs by less than the acceptable amount from the associated target value. The processor may be configured to determine the ground speed setting so that the throughput of the agricultural harvester remains substantially constant, with each of the plurality of current values differing by less than the acceptable amount from the associated target value, for a given amount of time, or a given distance of travel of the agricultural harvester, prior to the ground speed setting being determined so that the throughput increases. This applies to a scenario in which the current values of the quality parameters have returned to being within the acceptable amount after a period in which one or more of the current values were greater than the acceptable amount from their respective target value. In such a scenario, the automatic increase in the throughput is suppressed for a predefined time or distance (as described above)—throughout which the quality parameters remain in the acceptable range—prior to then again increasing the throughput using the ground speed setting. This may be advantageous to ensure that the quality parameters are under control in desired range and in a consistent manner before the controller attempts to automatically further improve performance of the harvester.

The at least one harvester automation setting may include a maximum ground speed. The processor may be configured to determine the ground speed setting to remain less than or equal to the maximum ground speed. In addition, or alternatively, the at least one harvester automation setting may include a maximum engine load. The processor may be configured to determine the engine load setting to remain less than or equal to the maximum engine load.

In general, the controller may control the ground speed and/or engine load of the harvester so as to keep increasing the throughput provided that the current values of the quality parameters are within the acceptable amount from the target values, and provided that the ground speed is less than the maximum speed and/or provided that the engine load is less than the maximum load. This ensures that maximum throughput of the harvester is achieved. In particular, when the current value of one or more of the plurality of quality parameters differs by greater than an acceptable amount from the associated target value, the at least one actuator setting may be determined in the first instance such that the throughput increases.

The at least one harvester automation setting may include operator target value data. The processor may be configured to adjust the target value of at least one of the plurality of quality parameters in dependence on the received operator target value data.

The processor may be configured to adjust the target value of at least one of the plurality of quality parameters so that: the associated current value changes from differing by greater than the acceptable amount from the target value to differing by less than the acceptable amount; or, the associated current value changes from differing by less than the acceptable amount from the target value to differing by greater than the acceptable amount.

The operator target value data may include feedback from an operator of the agricultural harvester that the target value of at least one of the quality parameters is: greater than an acceptable level; at an acceptable level; or, less than an acceptable level.

The target values stored by the controller may be the result of a calibration step performed for one or more of the on-board sensors. One or more of the target values may be incorrect for a variety of reasons. For example, certain weather conditions or a different crop type may result in the operator deeming one or more of the target values to be incorrect, or at least non-optimal. The operator may command adjustment of the target values if the controller takes too long to bring the quality parameters to acceptable levels with respect to current/default target values.

The at least one harvester automation setting may comprise at least one of: a crop type to be processed by the agricultural harvester; a maximum engine load of an engine of the agricultural harvester; a maximum rotor speed of one or more threshing rotors of the agricultural harvester; a level of threshing to be performed by the one or more threshing rotors; and, an automation strategy setting.

The plurality of on-board harvester sensors may comprise at least one of: an engine load sensor; a yield sensor; a moisture sensor; an inclination sensor; a feed-rate sensor; a returns volume sensor; a rotor loss sensor; a sieve loss sensor; a sieve load sensor; and, a grain quality sensor.

The plurality of quality parameters may comprise at least one of: a threshing losses parameter; a broken grain parameter; a cleaning losses parameter; a sample cleanliness parameter; and, a returns parameter.

The one or more actuator settings may comprise at least one of: a rotor speed of at least one threshing rotor of the agricultural harvester; a vane angle of at least one vane of the at least one threshing rotor; a fan speed of at least one fan of the agricultural harvester; an opening degree of a pre-sieve of the agricultural harvester; an opening degree of an upper sieve of the agricultural harvester; and, an opening degree of a lower sieve of the agricultural harvester.

The at least one harvester automation setting may comprise an allowable range of values for at least one of the actuator settings. The processor may be configured to determine the at least one actuator setting to be within the allowable range. This allows operators to tune particular settings to suit particular operating or harvesting conditions. It also allows operators to understand by how much the controller is changing the actuator settings.

The output may be configured to send a prompt signal to the operator-input device when the controller is unable to adjust the actuator settings to change the current value of one or more of the quality parameters from differing by greater than the acceptable amount from the associated target value to differing by less than the acceptable amount.

The prompt signal may include an indication of at least one of the target values and/or one or more of the harvester automation settings as the cause of the controller being unable to change the current value to be within the acceptable amount.

According to another aspect of the present invention there is provided a method of controlling a harvesting performance of an agricultural harvester. The method may comprise receiving at least one harvester automation setting, selected via an operator-input device. The method may comprise receiving crop sensor output data from a plurality of on-board harvester sensors. The method may comprise defining a target value for each of a plurality of quality parameters based on the at least one harvester automation setting. The method may comprise determining a current value of each of the plurality of quality parameters in dependence on the received crop sensor output data. The method may comprise determining an actuator setting for at least one actuator of the agricultural harvester when the current value of one or more of the plurality of quality parameters differs by greater than an acceptable amount from the associated target value, the at least one actuator setting being determined in dependence on the at least one harvester automation setting and said target value. The method may comprise sending an actuator control signal to the at least one actuator to achieve the associated determined actuator setting.

According to another aspect of the present invention there is provided a method of controlling a harvesting performance of an agricultural harvester. The method may comprise receiving at least one harvester automation setting, selected via an operator-input device. The method may comprise receiving crop sensor output data from a plurality of on-board harvester sensors. The method may comprise defining a target value for each of a plurality of quality parameters based on the at least one harvester automation setting. The method may comprise determining a current value of each of the plurality of quality parameters in dependence on the received crop sensor output data. The method may comprise sending a signal to the operator-input device to output the target values and the current values of the plurality of quality parameters. The method may comprise receiving operator target value data from the operator-input device. The method may comprise adjusting the target value of at least one of the plurality of quality parameters relative to the associated current value in dependence on the received operator target value data.

The operator target value data may include feedback from the operator of the agricultural harvester that the target value of at least one of the quality parameters is: greater than an acceptable level; at an acceptable level; or, less than an acceptable level.

According to another aspect of the present invention there is provided an agricultural harvester comprising a controller as described above.

### BRIEF DESCRIPTION OF THE DRAWINGS

One or more embodiments of the invention will now be described, by way of example only, with reference to the accompanying drawings, in which:

FIG. 1 is a schematic side view of an axial flow combine harvester, showing the components of a crop processing system of the harvester, and including an operator-input device located in an operator cabin of the combine harvester;

FIG. 2 is a schematic side view of the crop processing system of FIG. 1;

FIG. 3 is a schematic plan view of the combine harvester of FIG. 1, showing a controller of the harvester according to an embodiment of an aspect of the present invention, together with the inputs to, and outputs from, the controller;

FIG. 4 shows the steps of a method performed by the controller of FIG. 2 according to an aspect of the present invention;

FIG. 5 shows a display of the operator-input device of FIG. 1, the display showing a number of harvester automation settings to be input into the controller of FIG. 3;

FIG. 6 shows a display of the operator-input device of FIG. 1, the display indicating values of a plurality of crop quality parameters relative to respective target values;

FIG. 7 shows displays of the operator-input device of FIG. 1 in one operating scenario of the combine harvester, in particular:

FIG. 7(a) indicates a value of one of the crop quality parameters of Figure relative to the respective target value prior to the operator providing feedback regarding the target value;

FIG. 7(b) indicates options available to the operator to provide feedback regarding the target value of one of the crop quality parameters; and,

FIG. 7(c) indicates an updated value of the crop quality parameter relative to the respective target value after the operator has provided feedback;

FIGS. 8(a), 8(b) and 8(c) shows displays of the operator-input device of FIG. 1 equivalent to FIGS. 7(a), 7(b) and 7(c), respectively, but for another operating scenario of the combine harvester; and,

FIG. 9 shows a display of the operator-input device of FIG. 1, the display indicating sensitivity values (calibration values) of each of the crop quality parameters of FIG. 6.

### DETAILED DESCRIPTION OF THE DRAWINGS

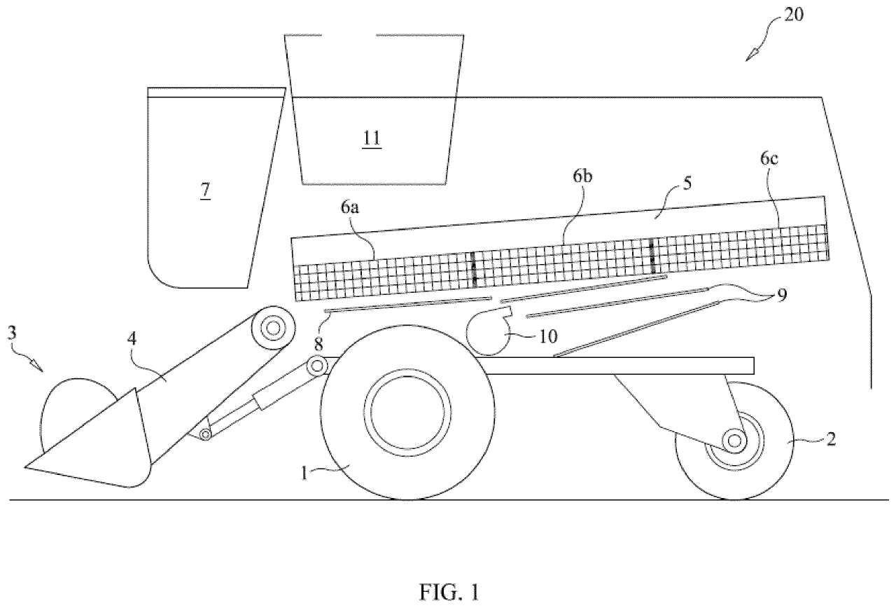

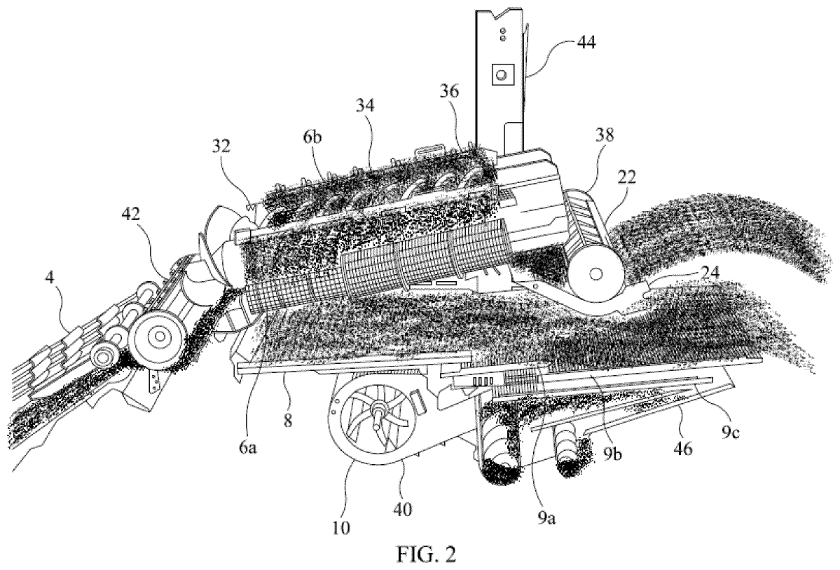

FIG. 1 shows the main components of an axial flow combine harvester 20, and FIG. 2 shows the components of a crop processing system and cleaning arrangement of the combine 20 is slightly greater detail. With reference to FIGS. 1 and 2, the combine 20 has front and rear wheels 1, 2 and a header assembly 3 for cutting crops from a field. The crops are supplied by a feeder 4 to a twin set of rotors 5, arranged along a longitudinal axis of the combine 20 and tilted slightly upwards with respect to the horizontal. The combine 20 has a crop processing system including rotors 5 that are rotatably mounted with respect to threshing concaves 6a and separation grates 6b, 6c. To the rear of the threshing concaves 6a and separation grates 6b, 6c is a straw beater cylinder 22 and a beater pan or separation grate 24. Residue from the threshing concaves 6a and separation grates 6b, 6c is thrown against the beater cylinder 22, which separates some additional grain not yet separated from the crop residue in the previous stages.

The combine 20 includes a driver's cabin 7 with an operator-input device 26 that communicates with a controller 28, which will be discussed in greater detail below. The combine 20 also includes a cleaning arrangement comprising a grain pan 8, a set of sieves 9 and a blower or fan 10 for blowing light residue material towards the back of the combine. In particular, the set of sieves 9 includes a pre-sieve 9a, an upper sieve 9b, and a lower sieve 9c. Grains fall through the sieves 9 and are transported by an assembly of augers and a grain elevator (not shown) to a grain tank 11.

The combine 20 includes a number of on-board harvester sensors, generally referred to by reference numeral 30, for measuring data relating to various aspects of the combine's performance. The sensors are shown schematically in FIG. 2. In particular, a feed-rate sensor 32 located in proximity to the feeder 4 measures the rate at which crop is being delivered from the feeder 4 to the rotors, an inclination sensor 34 measures the inclination of the combine 20, and yield and moisture sensors 36. For example, the yield and moisture sensors 36 may include a capacitive sensor and a mass-flow sensor in the form of an impact-based sensor or an optical beam-based sensor. The combine 20 also includes a rotor loss sensor 38 for measuring the amount of threshed crop that is not captured by the separation grates 6b, 6c and is instead disposed at the rear of the combine 20 with MOG. Also included is a sieve loss sensor 20 positioned in proximity with at least one of the sieves 9, and which measures the amount of crop that is being lost out of the rear of the combine 20 because of overloading (sieve off) or under loading (blow out) the sieves 9. A returns volume sensor 40 measures the amount of crop and MOG being fed back from the end of the lower sieve to the preparation pan. An engine load sensor 42 is used to measure a current load being placed on an engine of the combine 20, where the load varies in dependence on many factors including the speed at which the combine 20 is travelling, a weight of the combine 20 (which changes as crop is collected), and the particular field conditions in which the combine 20 is operating.

The combine 20 also includes a grain camera sensor 44, in particular a grain cam system, in which real-time images of the crop are taken and then analysed to determine a quality of the collected grain, for example including an indication of the percentage of cracked grain and/or MOG. In addition, the combine 20 includes one or more sieve load sensors 46 for determining the volume of material on the sieves 9: this information may then be used to determine the type of losses that are occurring in the combine 20.

The combine 20 includes a number of actuators, generally referred to by reference numeral 48, for controlling various actuation settings associated with the processing and cleaning systems of the combine 20. For example, one or more actuators may be used to adjust a rotation speed of the rotors 5, a speed of travel over the ground or field, i.e. ground speed, of the combine 20, and a rotation speed of the fan 10. One or more actuators are also used to control the size of the openings or gaps in each of the pre-sieve 9a, upper sieve 9b, and lower sieve 9c. In addition, actuators are used to adjust a vane angle of the rotors 5.

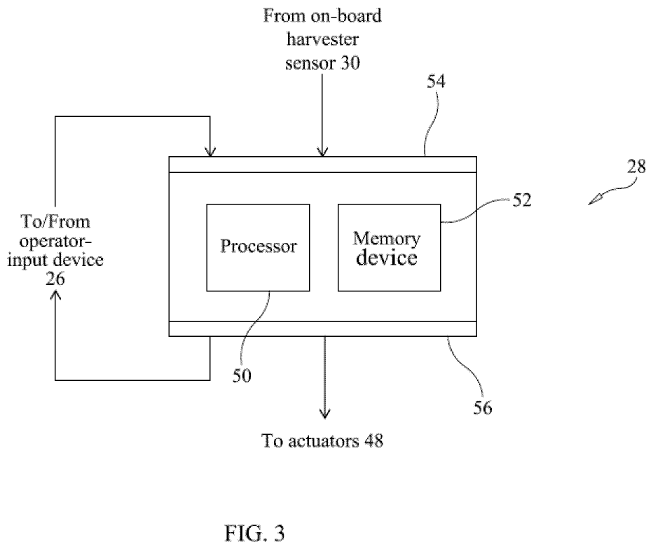

FIG. 3 shows a schematic view of the controller 28 located on-board the combine 20. In particular, the controller 28 includes one or more processors 50 and a memory device 52, together with an input 54 for receiving various electronic signals, and an output 56 for transmitting various electronic signals. Specifically, the input 54 receives sensor output data from each of the on-board harvester sensors 30, and also receives data from the operator-input device 26. The output 56 transmits control signals to the various actuators 48 to adjust the various actuation settings so as to control the harvesting performance of the combine 20. The output 56 also transmits signals to the operator-input device 26 with information pertaining to the harvesting performance of the combine 20 for relaying to the operator.

The controller 28 is operable to send control signals to cause automatic adjustment of the actuator settings in response to the received sensor data and any constraints provided by the operator via the operator-input device 26 so as to improve or optimise harvesting performance of the combine 20.

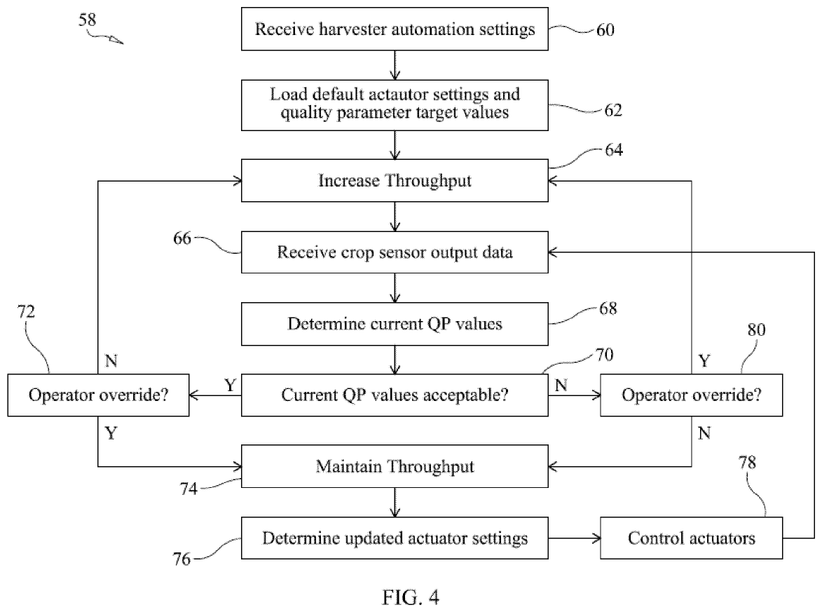

FIG. 4 shows the steps of a method 58 performed by the controller 28 to automate control of the internal processes of the crop processing and cleaning systems of the combine 20 so as to maximise harvesting capacity in varying harvesting and crop conditions. Initially, at step 60 the operator of the combine 20 inputs a number of automation settings into the operator-input device 26. In particular, the operator-input device 26 is a human-machine interface which, in the described embodiment has a touch-screen to facilitate operator input.

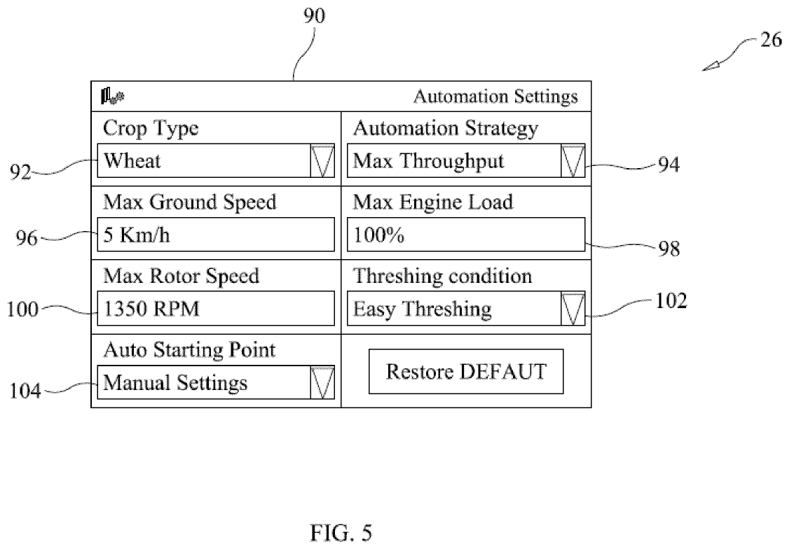

FIG. 5 shows a touch screen 90 of the described embodiment, in which various automation setting options are displayed. These automation settings set constraints to which the processing and cleaning systems of the combine 20 will operate and automatically adjust to harvest a field. As shown in FIG. 5, the operator can select the type of crop 92 that is to be harvested. In the described embodiment, the different crop types are wheat, canola, corn, and soybeans; however, different crop types are also possible.

The operator also selects a particular strategy 94 that the automated process should follow when harvesting, the options in the present embodiment being ‘maximum throughput’, ‘best grain quality’, ‘limited loss’ and ‘fixed throughput’. A maximum throughput strategy aims to maximise productivity immediately, and will aim to reach the maximum ground speed and maximum engine load. A limited loss strategy will aim to balance productivity, losses and contamination of the grain sample. A best grain quality strategy will aim for low contamination and a low level of broken grain. A fixed throughput strategy will aim to optimise for losses and contaminations without modifying the throughput.

The operator selects a maximum ground speed 96 that the combine 20 may reach during automated harvesting: for certain crop types, e.g. corn and canola, operating above a certain ground speed can result in feeder or header issues. The operator also selects a maximum engine load 98 for the combine 20. A default load may be 100%. In uniform fields with good feeding of crop material into the crop processing system, it may be possible to drive the combine 20 at the limits of the available power without blocking the crop processing system, and a maximum engine load may be, for example, 110%. In contrast, in non-uniform fields with variable crop feeding, there may be an increased risk of rotor blockage at high engine loads and so the maximum engine load may be set to be somewhat lower than capacity, for example 90%.

The operator may select a maximum speed 100 that the rotors 5 may reach. A default will be in place that differs for different crop types. The operator may wish to lower the maximum rotor speed in order to improve straw quality when swathing, for example. This may also be used to guard against a build-up of chaff in the cleaning arrangement.

The operator also selects a level of threshing to be performed, i.e. a threshing condition 102, for example ‘easy’, ‘medium’ or ‘hard’ threshing, which sets an allowable rotor vane range and an allowable rotor speed range. For instance, for wheat, easy threshing may have a vane range of 0-100% and a minimum rotor speed of 1100 rpm, medium threshing may have a vane range of 0-50% and a minimum rotor speed of 1175 rpm, and hard threshing may have a vane range of 0-0% and a minimum rotor speed of 1250 rpm. Easy threshing may be the default setting.

In the present embodiment the ‘Auto starting point’ setting 104 is then set to ‘Automation’ rather than ‘Manual’, which means that the controller 28 will automatically control harvesting performance of the combine 20 rather than the operator, as described in the following.

Returning to FIG. 4, at step 62 the controller 28 will load default or trained settings of the actuators 48 from the memory device 52 as an initial setting and will control the actuators 48 to assume this configuration. As part of this step, target values of a number of quality parameters are defined, also referred to as reference values or set-points. As mentioned above, these quality parameters indicate various aspects of harvester performance, and the target values indicate the values that the quality parameters should take in order to optimise the particular automation strategy that the combine 20 is undertaking.

Once these initial setup steps have been performed, the combine 20 can begin to harvest a field. In particular, at step 64 the controller 28 outputs a control signal to increase the throughput by controlling the ground speed of the combine 20. As the throughput increases, the amount of the crop being harvested per time unit through the processing and cleaning arrangements increases.

At step 66, the input 54 receives sensor output data from the plurality of on-board harvester sensors 30, and uses this sensor output data to determine current values of each of the quality parameters at step 68. In particular, the relative difference between the current values and the target or acceptable values of the quality parameters is used to assess the overall harvesting performance of the combine 20.

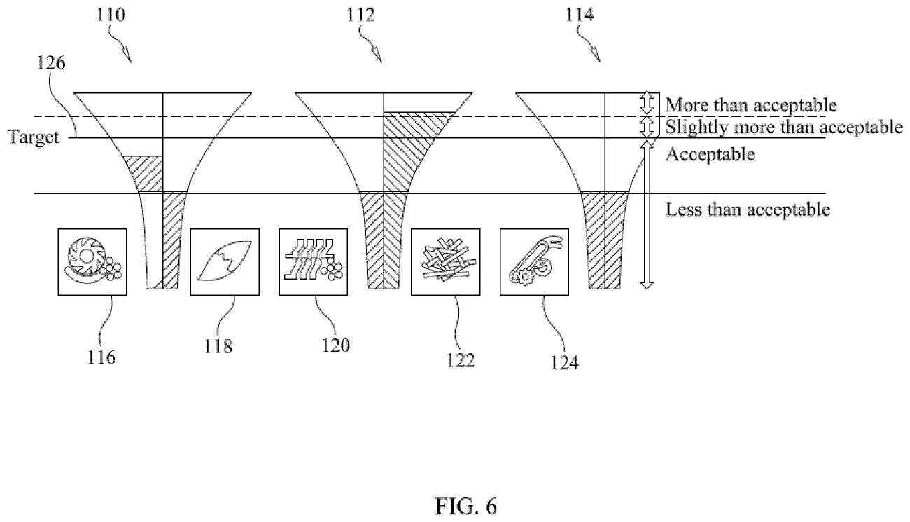

FIG. 6 shows a display of the touch screen 90 of the operator-input device 26 to give a visual indication to the operator of the overall harvesting performance. In particular, FIG. 6 shows a display indicating relative current and target values of the quality parameters. Specifically, FIG. 6 shows three funnels 110, 112, 114: the first funnel 110 relates to a threshing losses quality parameter 116 in the left half and a broken grain quality parameter 118 in the right half; the second funnel 112 relates to a cleaning losses quality parameter 120 in the left half and to a sample cleanliness quality parameter 122 in the right half; and, the third funnel 114 relates to a returns or tailings quality parameter 124. In addition, FIG. 6 shows a target value 126 of each of the quality parameters. Not that, although the target values of each of the quality parameters are shown as being equal, these target values are relative and adjustable and so the scale of each half-funnel changes if the associated target value changes.

FIG. 6 also shows the current value of each of the quality parameters relative to the associated target value by means of shading in each funnel. The colour of the shading may change in dependence on the current value of a quality parameter relative to its target value. For example, if the current value is less than the target value then the funnel may be shaded in a green colour (‘acceptable or less than acceptable’), if the current value is slightly greater than the target value then the funnel may be shaded in a yellow colour, and if the current value is significantly greater than the target value then the funnel may be shaded in a red colour. Note that, in addition to the target value 126, each quality parameter also has a further threshold 128 greater than the target value to indicate whether the current value is only slightly above the target value (‘slightly more than acceptable’) or whether the current value is significantly above the target value (‘more than acceptable’).

Returning again to FIG. 4, at step 70 the processor 50 determines whether the determined current value of each of the quality parameters is at an acceptable level. This may be done is different ways. For example, if the current value is less than the target value (irrespective of by how much) then the current value is deemed to be acceptable, whereas if the current value is above the target value then this is not acceptable. Alternatively, there may be a range of values, including the target value, that is deemed to be acceptable for the current value to be within, with values falling outside of the range being unacceptable. The target value may be the upper limit of such a range.

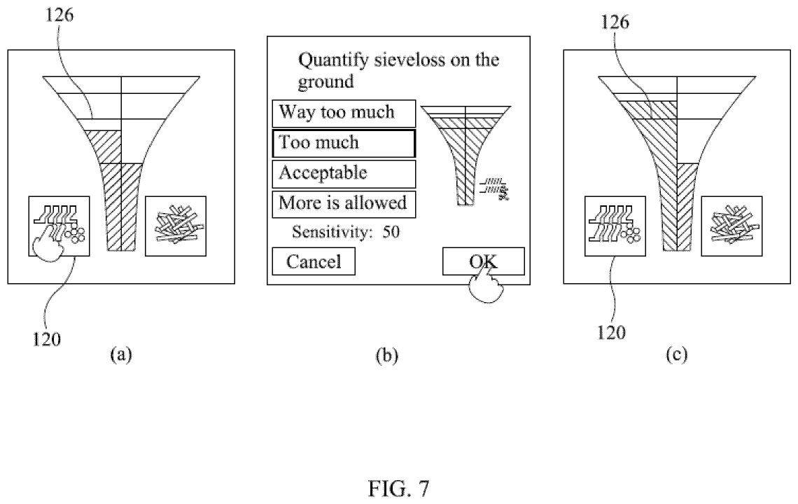

If at step 70 the current values of each of the quality parameters are deemed by the processor 50 to be acceptable then at step 72 the operator has the option to override this determination or provide feedback regarding this determination. In the described embodiment, if the operator takes no action at this stage then the process simply proceeds back to step 64 where the controller 28 continues to command an increase in throughput if automation settings (max ground speed/max engine load) allow this. If, however, the operator disagrees with the assessment that all of the quality parameters are at an acceptable level then at step 72 the operator can interact with the user-input device 26 to provide feedback to the controller 28. For example, if the operator disagrees that cleaning losses are at an acceptable level, then the operator can select the cleaning losses icon 120 as shown in FIG. 7(a) to bring up a pop-up screen as shown in FIG. 7(b). By visual inspection of the level of cleaning losses that are occurring during operation of the combine 20, the operator can select an option from the pop-up to best describe the situation. In particular, the operator may need to leave the cab 7 of the harvester 20 in order to assess the harvesting performance of the combine 20 before overriding the target value 126. As seen in FIG. 7(b), the options for the operator to input are that the cleaning losses level is ‘Way too much’, ‘Too much’, ‘Acceptable’ and ‘More is allowed’. In the example of FIG. 7(b), the operator selects that the cleaning losses is ‘Too much’. As shown in FIG. 7(c), this has the effect of adjusting the relative current level of the cleaning losses quality parameter from being below the target value to being above the target value. In fact, the operator's intervention has the effect of changing the target value 126 or sensitivity of the quality parameter so that the determined current value is now considered too high rather than acceptable.

The operator has therefore overridden the determination of the processor 50 and the method 58 of FIG. 4 then proceeds to step 74. The current value of the cleaning losses quality parameter is now at an unacceptable level and so the controller 28 acts to rectify this to get it back to an acceptable level. Firstly, at step 74 the controller 28 sends a signal to control the combine 20 to stop increasing its ground speed and instead to maintain a constant ground speed. This ensures that the crop throughput does not increase further.

At step 76, the processor 50 determines an updated set of actuator settings to bring each of the quality parameters back to acceptable levels. The processor 50 makes this determination with reference to the selected automation settings and to the (updated) target values of the quality parameters. In particular, the processor 50 uses fuzzy logic to make this determination, where the logic changes depending on crop type, and where the logic is based on a large amount of previous harvesting experience. At step 78, the output 56 sends a control signal to one or more of the actuators 48, as needed, to control the actuators 48 to assume the position or configuration determined at step 76. The process then cycles back to step 66 to check whether all of the quality parameters are now at an acceptable level.
Unlike as described above, if at step 70 the current value of at least one of the quality parameters is determined to be at an unacceptable level then the process will proceed to step 80. Like in step 72 above, if the operator simply takes no action at step 80 then the process will continue to step 74. In particular, as described above in the case where at least one of the quality parameters is not at an acceptable level, the controller 28 will attempt to bring the quality parameters back to acceptable levels by maintaining the ground speed of the combine 20 and automatically adjusting the settings of the actuators 48.

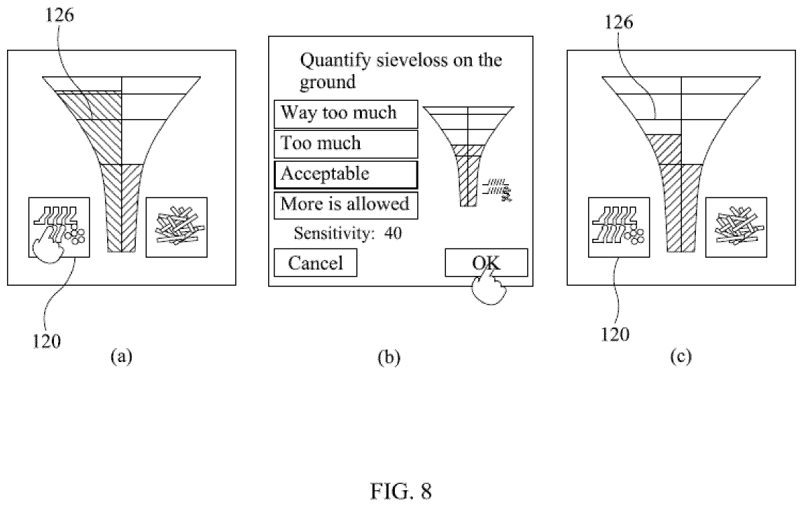

If at step 80, however, the operator disagrees that one of the quality parameters is at an unacceptable level, by visual inspection of the operation of the combine 20 or otherwise, like in step 72 above the operator can interact with the user-input device to provide feedback to the controller 28. For example, if the operator disagrees that cleaning losses are above an acceptable level, then the operator can select the cleaning or sieve losses icon 120 as shown in FIG. 8(a) to again bring up the pop-up screen, this time shown in FIG. 8(b). The operator then has the same four relative options to choose from based on his or her visual inspection of the combine's operation. As indicated in FIG. 8(b), if the operator selects that the cleaning losses are in fact at an acceptable level, then the current value of the cleaning losses changes from being shown as too high (as in FIG. 8(a)) to being at an acceptable level, as shown in FIG. 8(c). In particular, the target value is adjusted based on the operator's feedback from being less than the current cleaning losses to being greater than the current cleaning losses. As each of the quality parameters are now at an acceptable level the process loops back to step 64 and the controller 28 will continue to control the throughput. The throughput will continue to increase so long as the quality parameters remain at an acceptable level and until a maximum ground speed or maximum engine load (as defined in the automation settings) is reached.

In summary, the controller 28 will control the throughput to increase provided that each of the quality parameters are at an acceptable level, and that neither the maximum ground speed or the maximum engine load have been reached. When at least one of the quality parameters is not at an acceptable level, the controller 28 will first check if the quality parameters may be brought back to an acceptable level by increasing the throughput. This may be the case in the event of, for example, under-loaded threshing loss or under-loaded cleaning loss. If this is not successful, the controller 28 will control the throughput to remain substantially constant and command adjustment of one or more actuator settings in order to bring the quality parameters back to an acceptable level. Finally, if this is still not successful the controller 28 may command the throughput to decrease in order to solve the quality parameter issues.

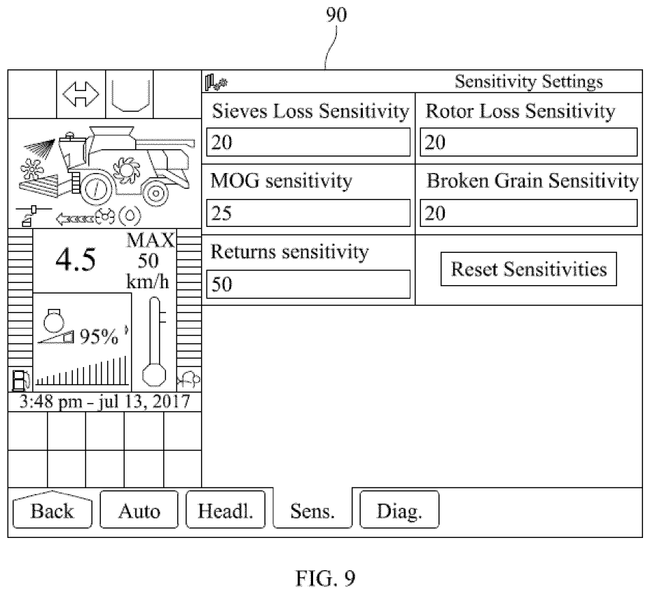

The above method 58 describes how the operator may provide feedback giving an opinion on the current values of quality parameters relative to the respective target values. As shown in FIG. 9, the operator may also adjust the scaling parameters of the quality parameters directly. In particular, the scaling parameters/sensitivity levels may be adjusted between 0 (non-sensitive) and 100 (very sensitive) non-dimensional units. These values may be adjusted by the operator prior to, or during, the automation process 58.

In the event that all of the current quality parameter values are at acceptable levels, the controller 28 is operable to automatically increase the throughput so as to increase the capacity of the combine 20. It may be that each of the quality parameters needs to be at an acceptable level for a given amount of time, or a given distance of travel of the combine 20, prior to the controller 30 automatically increasing the throughput.

In certain harvesting conditions, it may not be possible for the combine 20 to bring all of the quality parameters to acceptable levels. This may be because the target values have been set to unattainable or unrealistic set-points. The above method 58 allows to operator to intervene to adjust the target values during such conditions so that the combine 20 can make the necessary automatic adjustments to ensure that these set-points are attained. If the combine 20 is unable to automatically attain all of the target values, for example after a given time, the controller 28 may prompt the operator, via a pop-up on the operator-input device 26 for example, to adjust one or more of the target values or automation settings so that the combine 20 may achieve the targets.

There may be a particular setting constraint that is preventing the combine 20 from attaining the quality parameter target values. In such a case, the controller 28 may be operable to inform the operator via the operator-input device 26 which particular constraint that is causing the issue. Specifically, a capacity limiting factor icon is displayed on the operator-input device 26 to inform the operator which automation setting or target is causing the issue, and the operator is prompted or invited to adjust the indicated setting.

Furthermore, the operator may be able to define acceptable ranges for one or more of the actuators 48. That is, the operator may be able to set a range of values in which the controller 28 is permitted to adjust each actuator to when optimising the operation of the combine 20.

Many modifications may be made to the above-described embodiments without departing from the scope of the present invention as defined in the accompanying claims.

In the above-described embodiment, the operator actively intervenes at steps 72 and 80 to provide feedback regarding the quality parameters. In different embodiments, the operator may additionally or alternatively be prompted via the operator-input device for feedback in relation to the current values of the quality parameters relative to the target values.

1. A controller for controlling a harvesting performance of an agricultural harvester, the controller comprising:
an input configured to receive:
at least one harvester automation setting, selected via an operator-input device; and
crop sensor output data from a plurality of on-board harvester sensors;
a processor configured to:
define a target value for each of a plurality of quality parameters based on the at least one harvester automation setting;
determine a current value of each of the plurality of quality parameters in dependence on the received crop sensor output data; and
determine an actuator setting for at least one actuator of the agricultural harvester when the current value of one or more of the plurality of quality parameters differs by greater than an acceptable amount from the target value of the one or more of the plurality of quality parameters, the actuator setting being determined in dependence on the at least one harvester automation setting and the target value of the one or more of the plurality of quality parameters; and
an output configured to send an actuator control signal to the at least one actuator to achieve the determined actuator setting.

2. The controller according to claim 1, wherein the actuator setting includes a ground speed setting of the agricultural harvester, and the processor is further configured to determine the ground speed setting so that a throughput of the agricultural harvester remains at a substantially constant value or decreases when the current value of the one or more of the plurality of quality parameters differs by greater than the acceptable amount from the target value of the one or more of the plurality of quality parameters.

3. The controller according to claim 2, wherein the processor is configured to determine the ground speed setting so that the throughput increases when each of the plurality of current values differs by less than the acceptable amount from the target value of the one or more of the plurality of quality parameters.

4. The controller according to claim 3, wherein the processor is configured to determine the ground speed setting so that the throughput of the agricultural harvester remains substantially constant, with each of the plurality of current values differing by less than the acceptable amount from the target value of the one or more of the plurality of quality parameters, for a given amount of time, or a given distance of travel of the agricultural harvester, prior to the ground speed setting being determined so that the throughput increases.

5. The controller according to claim 3 or claim 4, wherein the at least one harvester automation setting includes a maximum ground speed, and the processor is configured to determine the ground speed setting to remain less than or equal to the maximum ground speed.

6. The controller according to claim 1, wherein the at least one harvester automation setting includes operator target value data, and the processor is configured to adjust the target value of the at least one of the plurality of quality parameters in dependence on the received operator target value data.

7. The controller according to claim 6, wherein the processor is configured to adjust the target value of the at least one of the plurality of quality parameters so that:
the current value of the at least one of the plurality of quality parameters changes from differing by greater than the acceptable amount from the target value to differing by less than the acceptable amount; or,
the current value of the at least one of the plurality of quality parameters changes from differing by less than the acceptable amount from the target value to differing by greater than the acceptable amount.

8. The controller according to claim 6, wherein the operator target value data includes feedback from an operator of the agricultural harvester that the target value of the at least one of the quality parameters is:
greater than an acceptable level;
at an acceptable level; or,
less than an acceptable level.

9. The controller according to claim 1, wherein the at least one harvester automation setting comprises at least one of:
a crop type to be processed by the agricultural harvester;
a maximum engine load of an engine of the agricultural harvester;
a maximum rotor speed of one or more threshing rotors of the agricultural harvester;
a level of threshing to be performed by the one or more threshing rotors; and,
an automation strategy setting.

10. The controller according to claim 1, wherein the actuator setting comprises at least one of:
a rotor speed of at least one threshing rotor of the agricultural harvester;
a vane angle of at least one vane of the at least one threshing rotor;
a fan speed of at least one fan of the agricultural harvester;
an opening degree of a pre-sieve of the agricultural harvester;
an opening degree of an upper sieve of the agricultural harvester; and,
an opening degree of a lower sieve of the agricultural harvester.

11. The controller according to claim 1, wherein the at least one harvester automation setting comprises an allowable range of values for the actuator setting, and the processor is configured to determine the actuator setting to be within the allowable range.

12. The controller according to claim 1, wherein the output is configured to send a prompt signal to the operator-input device when the controller is unable to adjust the actuator setting to change the current value of the one or more of the quality parameters from differing by greater than the acceptable amount from the target value of the one or more of the plurality of quality parameters to differing by less than the acceptable amount.

13. The controller according to claim 12, wherein the prompt signal includes an indication of at least one of the target values or the at least one harvester automation setting as the cause of the controller being unable to change the current value to be within the acceptable amount.

14. A method of controlling a harvesting performance of an agricultural harvester, the method comprising:
receiving at least one harvester automation setting, selected via an operator-input device;
receiving crop sensor output data from a plurality of on-board harvester sensors;
defining a target value (126) for each of a plurality of quality parameters based on the at least one harvester automation setting;
determining a current value of each of the plurality of quality parameters in dependence on the received crop sensor output data;
determining an actuator setting for at least one actuator of the agricultural harvester when the current value of one or more of the plurality of quality parameters differs by greater than an acceptable amount from the target value of the one or more of the plurality of quality parameters the actuator setting being determined in dependence on the at least one harvester automation setting and the target value of the one or more of the plurality of quality parameters; and
sending an actuator control signal to the at least one actuator to achieve the determined actuator setting.

15. (canceled)

16. An agricultural harvester comprising the controller of claim 1.
